(19) United States
(12) Patent Application Publication
(10) Pub. No.: US 2015/0324911 A1
(43) Pub. Date: Nov. 12, 2015

(54) DELTA-HEDGED FUTURES CONTRACT

(71) Applicant: Chicago Mercantile Exchange, Inc., Chicago, IL (US)

(72) Inventors: John Kerpel, Chicago, IL (US); John Labuszewski, Westmont, IL (US); John Nyhoff, Darien, IL (US); Richard Co, Chicago, IL (US); Lori Aldinger, Naperville, IL (US)

(73) Assignee: Chicago Mercantile Exchange, Inc., Chicago, IL (US)

(21) Appl. No.: 14/272,750

(22) Filed: May 8, 2014

(51) Int. Cl. G06Q 40/04

(52) U.S. Cl. CPC G06Q 40/04; G06Q 40/06

(57) ABSTRACT

Systems and methods are described for providing a futures product corresponding to a position in a delta-hedged strategy on an underlying financial product may include creating a portfolio including put options and call options, wherein the put options and the call options correspond to a same underlying product. One or more computing devices may determine a position in the underlying product to include in the portfolio. The position in the underlying product may correspond to a volatility of the put options and the call options. In some cases, the one or more computing devices may generate a futures contract based on the portfolio including the put options, the call options and the position in the underlying product.

### BACKGROUND

Options may be a popular investment vehicle due to a strictly limited associated risk, at least for an options buyer. In general, an options buyer may pay a cost of the option, known as the premium, upfront and in cash. Once paid, that premium represents the maximum possible loss to which the option buyer may be exposed. In many cases, options may be combined in different ways. For example, combinations of options may allow for different types of speculation and/or hedging. One such method is to buy (or sell) a call and a put, each having the same strike price and maturity. This combination may be referred to as a straddle. Straddles can be used to bet on large price movements of the product that underlies the option (e.g., the underlier). The bet may pay off when the underlier moves substantially in either direction. As such, a straddle may be considered to be a “play” on implied volatility.

A straddle is considered to be “at-the-money” when the strike price of the call equals the strike price of the put. A positive delta (e.g., a price difference) of the call may offset any negative delta of the put. As such, a straddle struck at-the-money has a net delta of zero. In such cases, when the net delta of the straddle is zero, the straddle position does not need to be delta hedged. In other words, no trades of the underlying product (e.g. a futures product) would need to be made against the straddle to keep the straddle position delta neutral. However, for those straddles that are not at-the-money, the net delta may be positive or negative. A positive delta may require the trader to delta hedge the position by selling enough futures to equal the value of the net delta. An important aspect of a delta-hedged straddle is to keep the position delta hedged so that any directional changes in the underlying product may be nullified. For example, in cases where the straddle is not delta hedged, the trader has no longer effectively isolated the volatility component of the straddle. As such, the trader may then face delta exposure. Over time, the delta associated with a straddle may change. For example, a straddle that may be at-the-money (e.g., zero net delta) on one particular day may be delta positive (or delta negative) on a subsequent day. As such delta hedging may be considered to be a continuous process to maintain the delta neutral status of the straddle.

Because an option premium is paid upfront and in cash, delta hedging may represent a significant opportunity cost for the straddle buyer. In some cases, a significant component of the option premium is known as “time value.” For example, consider an option to be analogous to an insurance policy. For an insurance policy, a longer term may result in a greater cost of insurance and/or a greater cost of the insurance premium. Similarly, an option having a longer term, holding other variables constant, increases the premium of the option accordingly. As such, option buyers are often reluctant to purchase expensive, longer-term options. However, they may still wish to secure the benefits of those options. As such, it would be desirable to provide a way to secure a future claim on a long, or short, straddle exposure while limiting upfront costs.

### SUMMARY

Systems and methods are described for providing a futures product corresponding to a position in a delta-hedged strategy on an underlying financial product. In some cases, a method may include creating, such as by one or more computing devices, a portfolio having put options and call options. The put options and the call options may correspond to a same underlying product and have a same maturity date. In some cases, the put options and the call options may have a same strike price. The computing devices may determine a position in the underlying product for inclusion in the portfolio. The position in the underlying product may correspond to a volatility of the options component, such as by delta hedging a difference between a price of the call options and a price of the put options. The one or more computing devices may then generate a futures contract based on the portfolio including the put options, the call options and the position in the underlying product. In some cases, the futures contract may provide a measure of implied volatility of the underlying financial product. In some cases, the futures product may be marked to market on a daily basis. In other cases, the futures product may be nearly continuously delta hedged using pricing information obtained from a financial market.

In some cases, a non-transitory computer readable medium may store instructions that, when executed by a processor, cause at least one computing device to determine a delta-hedged portfolio associated with a financial product, wherein the delta hedged portfolio includes a number of put options and call options associated with the financial product, and a position in the financial product corresponding to a delta between the put options and the call options. In some cases, the instructions may further cause the at least one computing device to generate a futures contract based on the delta-hedged portfolio. In some cases, at maturity of the futures product, the call options, the put options and the position in the underlying financial product may be delivered. In some cases, the futures product may be cash settled.

In some cases, a system for generating and/or managing a futures product based on a delta-hedged straddle may include one or more processors and a non-transitory memory device communicatively coupled to the one or more processors. The non-transitory memory device may store instructions that, when executed, may cause the one or more processors to generate a portfolio including a number of call options and a same number of put options. The call options and put options may correspond to a same underlying financial product and having a same expiration date and/or a same strike price. The instructions may further cause the one or more processors to calculate a delta associated with the call options and the put options. The calculated delta may be used to determine a position in the underlying financial product to make the portfolio delta neutral. The instructions may further cause the one or more processors to generate a futures contract based on the portfolio, wherein the futures contract corresponds to a volatility of the underlying financial product.

The details of these and other embodiments of the present invention are set forth in the accompanying drawings and the description below. Other features and advantages of the invention will be apparent from the description and drawings.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows an illustrative trading network environment for implementing trading systems and methods according to at least some embodiments.

FIG. 2 shows a portion of an illustrative system for determining and/or managing a futures contract on a delta-hedged portfolio in accordance with an aspect of the invention.

FIG. 3 shows an illustrative flow diagram 300 of a method for generating a futures contract on a delta-hedged portfolio in accordance with an aspect the invention.

### DETAILED DESCRIPTION

In some cases, a financial institution may desire to offer a financial product based on volatility of an underlying product. Because a delta-hedged straddle, or other such investment strategy (e.g., a strangle, a condor, a butterfly, a strap, a strip, etc.) corresponds to an implied volatility associated with the financial product underlying the investment strategy, a futures contract based on a delta-hedged straddle portfolio associated with a financial product may be created as a way to invest based on a measure of volatility of a market.

Straddles and strangles may be considered to be speculations on whether the price of an underlying financial product (e.g., a futures contract, a commodity, a stock, etc.) will move and whether the move will be large or small. In other words, straddles and strangles may be used to speculate whether an implied volatility of the financial product may go up or down, and by how much. For example, an investor may think that the price of a financial product may have a large movement in one direction or another and/or think that implied volatility may rise. In such cases, the investor may consider buying into a straddle or strangle. Conversely, if the trader may think that the financial product may stay flat, or not move very much, and/or if the implied volatility is thought to fall, the trader may sell short a straddle or strangle.

In an example, a long straddle includes a long call and long put of the same size, at the same strike price and expiration, and on the same financial product. A long strangle is long call at a higher strike and long put of the same size at a lower strike in the same expiration and on the same financial product. Such a position may make money if the stock price moves up or down well past the strike prices of the strangle. An advantage of long straddles and/or strangles is that they have limited risk but unlimited profit potential. One advantage of straddles and strangles is that they have a positive delta when the price of the underlying financial product increases and a negative delta when the price of the underlying financial product decreases. However, disadvantages of purchasing outright straddles and strangles may include large associated costs and that these strategies may be subject to large losses if the price of the underlying product has little movement.

In some cases, investment costs and/or margining associated with a delta-hedged futures product may be less than direct holding in a delta hedged investment strategy. For example, a trader having an outright position in a long delta-hedged straddle would be responsible for upfront payment of costs associated with the call option positions and the put options positions. Further, the trader would also be responsible for a margin requirement for the position in the underlying financial product. For a short delta-hedged straddle, the trader would be exposed to margin for the short put options, the short call options, and the delta-hedged position in the underlying financial product. However, by offering a the delta-hedged futures product, the trader is not subject to upfront costs for purchasing the call options and the put options, and would be responsible only for a margin requirement corresponding to the delta-hedged futures product itself. If physical delivery of the positions is desired upon maturity of the delta-hedged futures product, the trader would be subject to payment of the settlement price at that point and any margin requirement at the time of delivery. However, if cash settlement is desired, then the price and/or cost to the trader at the time of maturity would be determined by adding the price for each component at the time the position in the delta-hedged futures product is closed.

In some cases, the delta-hedged portfolio may include a specified number of put options and a same specified number of call options associated with the financial product. The call options and the put options may originally be purchased “at the money”, meaning that the price of the call options equals the price of the put options at a time of purchase. The option(s) may be an option on a futures contract, such as those currently traded on a financial exchange (e.g., the CME Group exchanges). Such options may include an option on a security; an option on an over-the-counter (OTC) instrument; an option on a commodity; or an option on such other instruments that may be available.

Other strategies may include butterflies, condors, straps and strips, to name a few. A butterfly may be considered a neutral option strategy. A butterfly position may include four options contracts with the same expiration, but including three different strike prices to create a range of prices upon which the strategy may profit. In some cases, an investor may sell two options at a middle strike price and buys one option contract at a lower strike price and another option contract at a higher strike price. Both puts and calls may be used in a butterfly spread. A butterfly spread may have limited risk (e.g., loss of an initial investment), but a maximum return may be encountered when the price of the underlying financial product remains near the middle strike price.

A condor (e.g., an iron condor) may include holding four different options with different strike prices. The iron condor may be constructed by holding a long position and a short position in two different strangles. As discussed above, the strangle may be created by buying (or selling) a call option and a put option with different strike prices, but having a same expiration date. By using the iron condor strategy, a potential for profit or loss may be limited by using an offsetting strangle positioned around the two options that make up the strangle at the middle strike prices. This strategy may be used when a trader has a neutral outlook on the movement of the underlying security from which the options are derived. While the iron condor is very similar in structure to an iron butterfly, however, the two options located in the center of the pattern do not have the same strike prices. By using a strangle at the two middle strike prices, profits may be obtained over a larger range of prices, but this also lowers an overall profit potential.

A strap is an options strategy created by being long in one put and two call options. The put option and the call options all have the same strike price, maturity and underlying asset. A strap option may be used when an investor may foresee large pricing movements in an underlying security, where the movements are more likely to be up than down. With the two call options the investor may secure a large gain if the large upward movement occurs as expected. However, if the price falls, the investor may be protected somewhat by the put option.

A strip may be considered to be a modified version of a straddle, where a number of at the money calls and twice the number of puts of the same underlying product, and having a same strike price and expiration date. Strips may allow for unlimited profit potential, with limited risk. The strip strategy may be used when an investor believes that an price of the underlying product may experience a large amount of volatility in the near term and may be likely to drop downwards rather than increasing. In some cases, while investors may profit by large movements in either direction, a higher profit potential exists for downward price movement of the underlying product.

The portfolio may also include a position in the underlying financial product (e.g., a stock futures product, a bond futures product, a commodities futures product, etc.) corresponding to a delta between a price of the put options and a price of the call options. When a futures contract based on the delta-hedged portfolio is created, thus creating a futures contract on implied volatility of the underlying product. The call options and the put options may correspond to a long position in the underlying financial product, such as by holding long call options and long put options in the portfolio. In other cases, the call options and the put options may correspond to a short position in the underlying financial product, such as by holding short call options and short put options in the portfolio. The size of the position in the underlying financial product (e.g., a number of long or short futures contracts) combined with the long or short option straddle position will establish a “delta neutral” exchange traded derivatives portfolio.

In some cases, the futures contract may be configured for the delivery, upon maturity, of holdings in the portfolio upon which the futures contract is based. For example, the delivered portfolio may include a number (e.g., 100) long (or short) put options in the financial product, the same number (e.g., 100) of long (or short) call options in the financial product, where the put options and the call options share the same strike price and expiration date, thus defining an option straddle on the underlying financial product. The portfolio may further include a long or short position in the underlying financial product (e.g., a futures contract) equal to (−1.00) multiplied by an aggregate net delta of the long (or short) straddle position. Because, in some cases, a purchase of a fractional number of shares in the underlying financial product is not possible, the number of call options and put options defined in the portfolio may be chosen to allow for the delta-hedging calculation to result in a whole number of shares in the underlying financial product being held. For example, when the underlying financial product is a futures contract, only whole number sized lots may be bought and/or sold.

However, a futures contract based on a delta-hedged portfolio may be cash settled, rather than delivering the underlying options and futures at contract maturity. In such cases, the contract may be easily marked to market each day using the option prices, deltas and the closing price of the delta hedged underlying financial product. As such, the number of call options and put options are not limited to a number that would result in a whole number sized lot of the underlying financial product. Because the portfolio may be managed “virtually”, using the option prices, calculated deltas and a market price of the delta hedged underlying financial product.

The put options and the call options may represent an option straddle where the included options share the same strike and expiration date. The number of futures contracts to be included in the derivatives portfolio may be based on the net delta of a 100 lot option straddle position, such that a whole number of the underlying futures contract may be purchased for delta-hedging the straddle position. As mentioned above, such options may be an option on a futures contract such as those currently traded on CME Group exchanges, such as an option on a security; an option on an over-the-counter (OTC) instrument; an option on a commodity; or an option on such other instruments that may be available.

In an illustrative example, assume that a futures contract that expires on the third Friday of December 2013 requires the delivery of an option on S&P 500 futures straddle with a strike price equal to $1,700. The buyer of the futures contract will be the buyer of the options portion of the delivered derivatives portfolio and, as such, will be long on implied volatility. The seller of the futures contract will be the seller of the options portion of the derivatives portfolio and will be short on implied volatility.

The option on S&P 500 futures $1,700 strike price straddle may expire on any business day after the third Friday of December. In this case, assume that this straddle expires on the third Friday of March 2014. The options to be delivered will be priced using either the implied volatility associated with a listed option or an interpolated implied volatility based on the two closest to expiry options that encapsulate the term to expiration of the delivered options. For example:

At expiration, the March S&P 500 futures may be trading at $1675 and the delivered straddle strike price is $1700. As such, the implied volatility is 15%. The fair market value of the long $1700 call may thus equal $39.40 with a delta=+0.44 and the fair market value of the long $1700 put may thus equal $63.10 with a delta=−0.56. As such, the delta hedged portfolio requires the delivery of 12 long futures contracts using the equation (−1)*[(100*(+0.44))+(100*(−0.56))]=+12. Hence the buyer of the futures contract will receive the following derivatives portfolio upon futures delivery: (1) 100 long March 2014 S&P 500 $1700 strike price call options, (2) 100 long March 2014 S&P 500 $1700 strike price put options, and (3) 12 long March 2014 S&P 500 Futures. In other cases, rather than delivering the derivatives portfolio, the futures contract on the delta-hedged portfolio may be cash-settled.

Exemplary Operating Environment

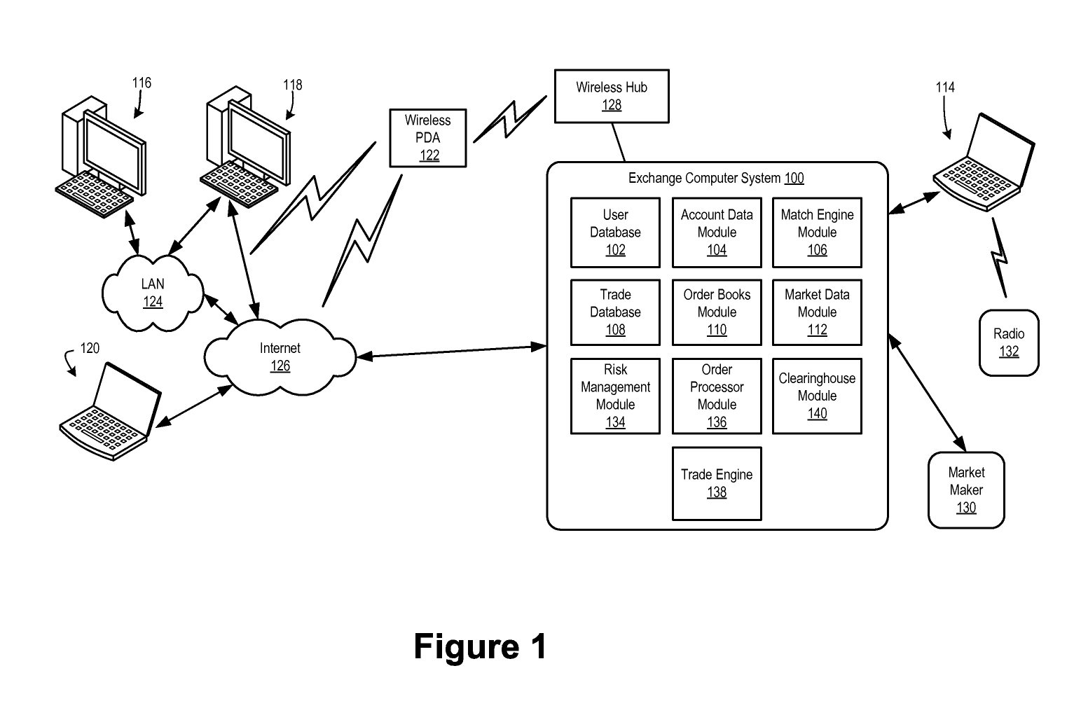

Aspects of at least some embodiments can be implemented with computer systems and computer networks that allow users to communicate trading information. An exemplary trading network environment for implementing trading systems and methods according to at least some embodiments is shown in FIG. 1. The implemented trading systems and methods can include systems and methods, such as are described herein, that facilitate trading and other activities associated with financial products based on currency pairs.

Computer system 100 can be operated by a financial product exchange and configured to perform operations of the exchange for, e.g., trading and otherwise processing various financial products. Financial products of the exchange may include, without limitation, futures contracts, options on futures contracts (“futures contract options”), and other types of derivative contracts. Financial products traded or otherwise processed by the exchange may also include over-the-counter (OTC) products such as OTC forwards, OTC options, etc.

Computer system 100 receives orders for financial products, matches orders to execute trades, transmits market data related to orders and trades to users, and performs other operations associated with a financial product exchange. Exchange computer system 100 may be implemented with one or more mainframe, desktop or other computers. In one embodiment, a computer device uses one or more 64-bit processors. A user database 102 includes information identifying traders and other users of exchange computer system 100. Data may include user names and passwords. An account data module 104 may process account information that may be used during trades. A match engine module 106 is included to match prices and other parameters of bid and offer orders. Match engine module 106 may be used to match bids and offers for future contracts discussed below. Match engine module 106 may be implemented with software that executes one or more algorithms for matching bids and offers.

A trade database 108 may be included to store information identifying trades and descriptions of trades. In particular, a trade database may store information identifying the time that a trade took place and the contract price. An order book module 110 may be included to store prices and other data for bid and offer orders, and/or to compute (or otherwise determine) current bid and offer prices. A market data module 112 may be included to collect market data, e.g., data regarding current bids and offers for futures contracts, futures contract options and other derivative products. Module 112 may also prepare the collected market data for transmission to users. A risk management module 134 may be included to compute and determine a user's risk utilization in relation to the user's defined risk thresholds. An order processor module 136 may be included to decompose delta based and bulk order types for further processing by order book module 110 and match engine module 106.

A clearinghouse module 140 may be included as part of exchange computer system 100 and configured to carry out clearinghouse operations. Module 140 may receive data from and/or transmit data to trade database 108 and/or other modules of computer system 100 regarding trades of futures contracts, futures contracts options, OTC options and contracts, and other financial products. Clearinghouse module 140 may facilitate the financial product exchange acting as one of the parties to every traded contract or other product. For example, computer system 100 may match an offer by party A to sell a financial product with a bid by party B to purchase a like financial product. Module 140 may then create a financial product between party A and the exchange and an offsetting second financial product between the exchange and party B. As another example, module 140 may maintain margin data with regard to clearing members and/or trading customers. As part of such margin-related operations, module 140 may store and maintain data regarding the values of various contracts and other instruments, determine mark-to-market and final settlement amounts, confirm receipt and/or payment of amounts due from margin accounts, confirm satisfaction of final settlement obligations (physical or cash), etc. As discussed in further detail below, module 140 may determine values for performance bonds associated with trading in products based on various types of currency pairs.

Each of modules 102 through 140 could be separate software components executing within a single computer, separate hardware components (e.g., dedicated hardware devices) in a single computer, separate computers in a networked computer system, or any combination thereof (e.g., different computers in a networked system may execute software modules corresponding more than one of modules 102-140).

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may implement one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics, radio links or other media.

A wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet. Computers 116, 118 and 120 may communicate with each other via the Internet 126 and/or LAN 124.

One or more market makers 130 may maintain a market by providing constant bid and offer prices for a derivative or security to exchange computer system 100. Exchange computer system 100 may also include trade engine 138. Trade engine 138 may, e.g., receive incoming communications from various channel partners and route those communications to one or more other modules of exchange computer system 100.

One skilled in the art will appreciate that numerous additional computers and systems may be coupled to exchange computer system 100. Such computers and systems may include, without limitation, additional clearing systems (e.g., computer systems of clearing member firms), regulatory systems and fee systems.

The operations of computer devices and systems shown in FIG. 1 may be controlled by computer-executable instructions stored on non-transitory computer-readable media. For example, computer device 116 may include computer-executable instructions for receiving market data from exchange computer system 100 and displaying that information to a user. As another example, clearinghouse module 140 and/or other modules of exchange computer system 100 may include computer-executable instructions for performing operations associated with determining performance bond contributions associated with holdings in products that are based on various types of currency pairs.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

### Exemplary Embodiments

In some cases, the exchange computing system 100 may be configured to create and/or manage a futures contract in a delta-hedged straddle position in an underlying financial product. In at least some embodiments, the exchange computer system 100 (or “system 100”) receives, stores, generates and/or otherwise and processes data. In accordance with various aspects of the invention, the exchange computing system 100 may obtain pricing information corresponding to the underlying financial product from a financial market. This may promise a more straight-forward way for investors to take a position based on implied volatility of a financial product.

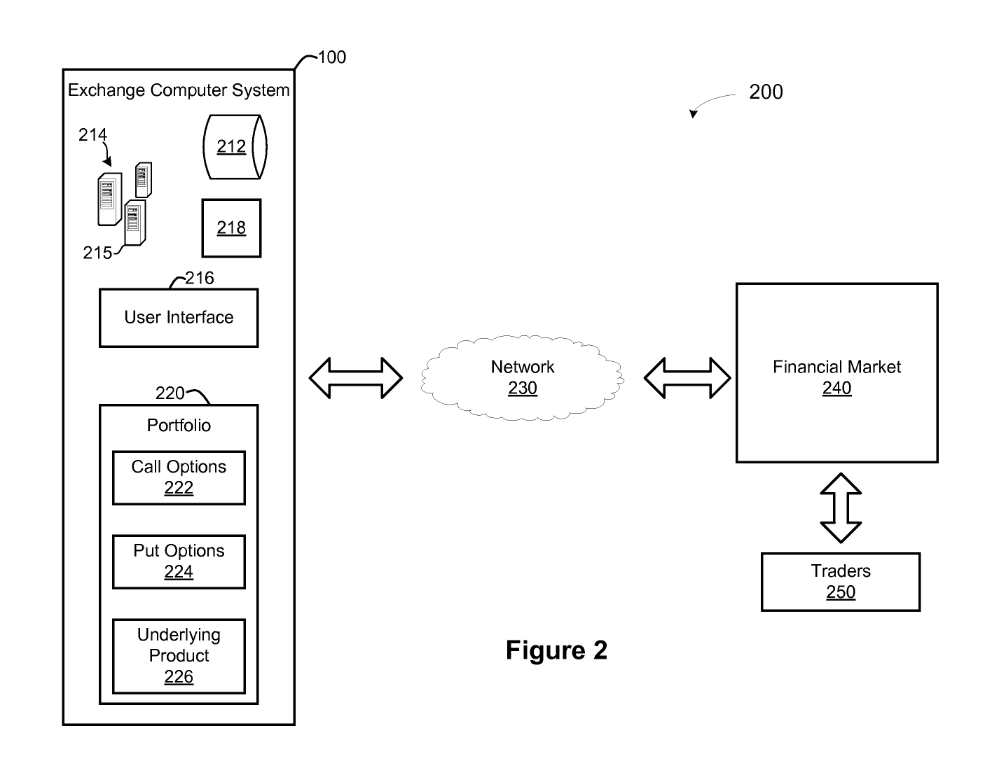

FIG. 2 shows a portion of an illustrative system 200 for determining and/or managing a futures contract on a delta-hedged portfolio in accordance with an aspect of the invention. In some cases, the illustrative system 200 may include an exchange computing system 100 communicatively coupled to a financial market 240 via a network 230 (e.g., a wide area network (WAN), the LAN 124, the Internet 126, etc.). The exchange computer system 100 may include a data repository 212, one or more computing devices 214, and, in some cases, at least one user interface 216. In some cases, a financial exchange may desire to offer an implied volatility product to traders 250 via the financial market 240. The implied volatility product may be based on a delta-hedged straddle of an underlying financial product that may also be traded via one or more financial markets, such as the financial market 240. Such underlying financial products may include a stock futures contract, a bond futures contract, a commodity futures contract, a currency futures contract, and the like.

In some cases, a user of the exchange computer system 100 may select a particular futures contract for use in creating a delta-hedged futures contract. In other cases, a computing device 215 may process instructions stored in the data repository, to process trading information obtained from the financial market to determine which underlying financial product(s) may be used to create a delta-hedged futures contract that may be marketable to a particular class or group of the traders 250. For example, the computing device 215 may process trading information to determine that a particular futures contract may be likely to have a larger target market of traders 250 than another.

Once the underlying financial product has been determined, such as by the computing device 215, a portfolio 220 may be developed for use in creating the delta-hedged futures contract. For example, the portfolio 220 may include a number of call options 222 and a same number of put options 224. In some cases, the strike price of the call options and the put options may be the same, or “at the money”. At the time of purchase, the net delta of an “at the money” transaction is zero. However, after the time of purchase the prices of the call options and put options may vary over time, thus resulting in residual delta. For example, as the underlying instrument price moves, the straddle position may move resulting in some net delta. Because a pure volatility play is desired for the delta-hedged futures contract, the positions in the call options and put options are delta-hedged by buying (or selling) a position in the underlying financial product to neutralize the effect, such as the underlying product position 226. In some cases, this delta hedging may be performed at the end of a trading day, such as by a clearinghouse module 140 when marking the portfolio 220 to the market. In other cases, it may be desirable to delta-hedge the portfolio 220 at intervals over time, such as at set intervals over a trading day. In some cases, the computing devices 124 may be capable of continuously, or nearly continuously, delta-hedging the portfolio 220 using pricing information obtained via the network 230 from the financial market 240.

In some cases, such as when delivery of the products is desired, the number of call options and put options may be quoted as a lot of a hundred shares. For example, when calculating delta associated with a futures contract as the underlying contract, the number of futures contracts is limited to a whole number because purchases of fractional futures contracts are not possible. For example, if a delta is calculated to be less than 1, it is not possible to have a fractional amount (e.g., 0.2) of an options contract. As such, by using a lot size of 100, the decimal place may be moved two places, allowing for a whole number of options contracts to be included in the portfolio 220. For example if delta has been calculated as 0.21, it is not possible to purchase 0.21 or 2.1 options contracts, but it is possible to purchase 21. One disadvantage of the physical delivery option is that a 100 lot of puts and calls creates a large obligation for an investor in the delta-hedged futures product. In some cases, smaller lots of options contracts may be used. In such cases, any fractional amount of futures contracts may be rounded to a nearest integer at the inception of the trade. However, this rounding may introduce error into the delta-hedging calculation.

In some cases, physical delivery is not desired. Rather, cash settlement may be preferred. In such cases, the computing device 215 may obtain a price of the call options 222 and the put options 224, such as via the network 230 from the financial market 240. The computing device 215 may analytically derive a net delta using this pricing information, where the resulting delta may kept on the books, such as by being stored in memory and/or the data repository 212. As such, a portfolio 220 may be created having a single call option 222, a single put option 224 and a fractional amount of the underlying product 226. By doing this, nothing may be traded physically, and a position may be cash settled at the end of the associated term. Also, by doing these calculations, the computing device may be able to delta hedge the portfolio 220 on a near continuous, or otherwise frequent, basis. As such, a cash settled position may allow more investment options in a delta-hedged futures product, and/or may allow more investors access to such an investment vehicle. For example, a 100 lot, or larger, straddle may be too cost prohibitive for a smaller investor to purchase.

In general, a delta associated with a financial product may be considered to be a measure of volatility for the financial product. For example, the delta corresponds to a first derivative of an option price with respect to the underlier (e.g., the underlying financial product), and may provide a measure of how much the option price may move in response to a one dollar move in price. By computing the delta, a calculation may be performed to neutralize, or hedge, the net effect of the price move. For example, an appropriate amount of the underlier may be purchased, or sold, to offset the net delta. A delta of a put is negative (−) and a delta of a call is positive (+) and can be combined to offset the net delta of the portfolio 220. Because the price of the underlier changes from the original strike price, the delta will change over time, which results in a need for hedging the residual data.

An illustrative system may include one or more computing devices 214 that may include one or more processors and at least one non-transitory memory device communicatively coupled to the one or more processors. The non-transitory memory device may store instructions that, when executed by the processors, cause the one or more computing devices 214 to generate a portfolio including a number of call options and a same number of put options, calculate a delta associated with the call options and the put options to include a position in the underlying financial product to make the portfolio delta neutral, and generate a futures contract based on the portfolio, wherein the futures contract corresponds to a volatility of the underlying financial product. In some cases, the call options 222 and put options 224 may correspond to a same underlying financial product and having a same expiration date.

In some cases, the instructions, when executed, may further cause the computing device to deliver, upon maturity of the futures contract, the number of call options, the same number of put options, and the position in the underlying financial product to make the call options and put options delta neutral, wherein the position in the financial product is determined using a price at the time of maturity of the futures contract.

The illustrative system may further include a network interface 218 communicatively coupling the one or more processors of the one or more computing devices 214 to the financial market 240, where the one or more computing devices 214 may be configured to obtain a pricing information about the underlying financial product from the financial market via the network interface 218, calculate the delta associated with the call options and the put options based on the pricing information, and determine a position in the underlying financial product to make the portfolio delta neutral using the delta calculated using the pricing information. In some cases, the one or more computing devices may obtain the pricing information about the underlying financial product at an end of a trading day. In some cases, the pricing information may be obtained about the underlying financial product at regular intervals during a trading day over a lifetime of the financial product.

In some cases, the number of call options 222 may equal the number of put options 224, and wherein the number (e.g., 1, 2, 15, etc.) is chosen to allow the determined position in the underlying financial product to include a fractional number of shares in the underlying financial product. In other cases, the number may be chosen to allow the determined position in the underlying financial product to include a whole number of shares in the underlying financial product, such as by choosing the number to be a multiple of 10, a multiple of 100, and the like.

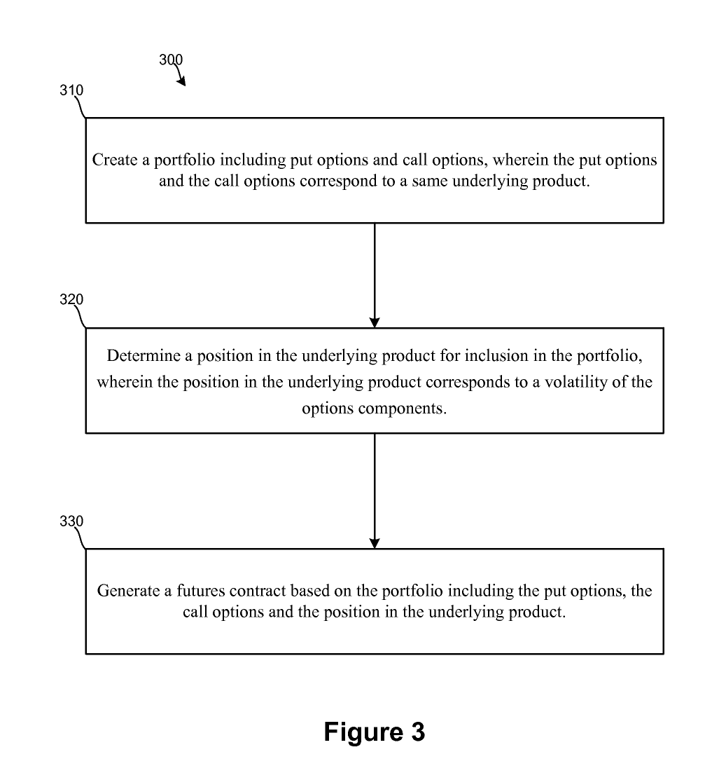

FIG. 3 shows an illustrative flow diagram 300 of a method for generating a futures contract on a delta-hedged portfolio in accordance with an aspect the invention. For example, at 310, the one or more computing devices 314 may be configured for creating a portfolio 220 including put options 224 and call options 222. The put options 224 and the call options 222 may correspond to a same underlying product. In some cases, the portfolio 220 may include a number of call options 222 and a same number of put options 224, where the call options 222 and the put options 224 may have the same strike price and expiration. In some cases, the portfolio 220 may include a number of call options 222 and a same number of put options 224, where the call options 222 and the put options 224 may have different strike prices and a same expiration. In some cases, the call options 222 and the put options 224 may correspond to long positions in the underlying component and in other cases, the call options 222 and the put options 224 may correspond to short positions in the underlying component. In some cases, the number of call options 222 and number of put options 224, an associated strike price and/or an associated expiration may be chosen based on a particular investment strategy, such as a straddle, a strangle, a butterfly, a condor, a strap, a strip, and the like.

At 320, the one or more computing devices 214 may be configured for determining a position in the underlying product to include in the portfolio, wherein the position in the underlying product corresponds to a volatility of the options components. In some cases, the computing devices 214 may calculate a net delta between the call options 222 and the put options 224 and determine a position in the underlying financial product based on the net delta between the call options 222 and the put options 224. In some cases, the net delta may be calculated on a daily basis, such as to mark-to-market the portfolio 220. In other cases, the net delta may be calculated on a more frequent basis (e.g., periodically during a trading day) or nearly continuously. For example, the net delta may be calculated upon expiration of a predetermined time period (e.g., less than 1 minute, about 1 minute, about 5 minutes, about 1 hour, about 1 day, etc.).

At 330, the one or more computing devices 214 may be configured for generating a futures contract based on the portfolio including the put options, the call options and the position in the underlying product and/or offering the futures contract to one or more traders 250 via the financial market 240. In some cases, the components of the portfolio 220 underlying the futures contract (e.g., delta-hedged futures contract) may be delivered upon expiration. In other cases, the portfolio may be cash settled based on a price of a call option, a price of a put option, a calculated delta between the call option and the put option, and a closing price of the underlying financial product.

In another illustrative example, a method may include determining a delta-hedged portfolio associated with a financial product, wherein the delta hedged portfolio includes a number of put options and call options associated with the financial product, and a position in the financial product corresponding to a delta between the put options and the call options. The method may then include generating a futures contract based on the delta-hedged portfolio, where the delta-hedged futures contract corresponds to an implied volatility of the underlying financial product. In some cases, the future contract comprises a delta hedged futures product based on a delta-hedged portfolio comprising one of a delta neutral straddle and a delta neutral strangle. In some cases, the delta-hedged futures contract may be cash-settled upon maturity of the futures contract.

The present invention has been described herein with reference to specific exemplary embodiments thereof. It will be apparent to those skilled in the art that a person understanding this invention may conceive of changes or other embodiments or variations, which utilize the principles of this invention without departing from the broader spirit and scope of the invention as set forth in the appended claims.

What is claimed is:

1. A method comprising:
creating a portfolio including put options and call options, wherein the put options and the call options correspond to a same underlying product;
determining, by the one or more computing devices, a position in the underlying product to include in the portfolio, wherein the position in the underlying product corresponds to a volatility of the put options and the call options; and
generating a futures contract based on the portfolio including the put options, the call options and the position in the underlying product.

2. The method of claim 1, wherein the portfolio includes a number of call options and a same number of put options, the call options and the put options having a same strike price and expiration.

3. The method of claim 1, wherein the portfolio includes a number of call options and a same number of put options, the call options and the put options having different strike prices and a same expiration.

4. The method of claim 1, wherein the call options and the put options correspond to long positions in the underlying component.

5. The method of claim 1, wherein the call options and the put options correspond to short positions in the underlying product.

6. The method of claim 1, wherein the call options and the put options of the portfolio correspond to one of a straddle and a strangle.

7. The method of claim 1, wherein the call options and the put options of the portfolio correspond to one of a condor, a butterfly, a strip, and a strap.

8. The method of claim 1, comprising:
calculating, by the one or more computing devices, a net delta between the call options and the put options; and
determining, by the one or more computing devices, the position in the underlying financial product based on the net delta between the call options and the put options.

9. The method of claim 8, wherein the portfolio is marked-to-market daily based on a calculated net delta between the call options and the put options and a price associated with the underlying financial product.

10. The method of claim 8, wherein the portfolio is cash settled based on a price of a call option, a price of a put option, a calculated delta between the call option and the put option, and a closing price of the underlying financial product.

11. A non-transitory computer readable medium storing instructions that, when executed, cause at least one computing device to:
determine a delta-hedged portfolio associated with a financial product, wherein the delta hedged portfolio includes a number of put options and call options associated with the financial product, and a position in the financial product corresponding to a delta between the put options and the call options; and
generate a futures contract based on the delta-hedged portfolio.

12. The non-transitory computer readable medium of claim 11, wherein the delta-hedged portfolio comprises a delta neutral straddle.

13. The non-transitory computer readable medium of claim 11, wherein the delta-hedged portfolio is cash-settled upon maturity of the futures contract.

14. The non-transitory computer readable medium of claim 11, wherein the futures contract corresponds to an implied volatility of an underlying financial product.

15. A system comprising:
one or more processors;
a non-transitory memory device communicatively coupled to the one or more processors, the non-transitory memory device storing instructions that, when executed, cause the one or more processors to:
generate a portfolio including a number of call options and a same number of put options, the call options and put options corresponding to a same underlying financial product and having a same expiration date;
calculate a delta associated with the call options and the put options to include a position in the same underlying financial product to create a delta-neutral portfolio; and
generate a futures contract based on the portfolio, wherein the futures contract corresponds to a volatility of the same underlying financial product.

16. The system of claim 15, wherein the non-transitory memory stores further instructions that, when executed, cause the one or more processors to:
deliver, upon maturity of the futures contract, the number of call options, the same number of put options, and the position in the underlying financial product to make the call options and put options delta neutral, wherein the position in the financial product is determined using a price at a time of maturity of the futures contract.

17. The system of claim 15, further comprising a network interface communicatively coupling the one or more processors to a financial market, wherein the non-transitory memory stores further instructions that, when executed, cause the one or more processors to:
obtain a pricing information corresponding to the underlying financial product from the financial market via the network interface; and
calculate the delta associated with the call options and the put options based on the pricing information; and
determine a position in the underlying financial product to create a delta-neutral portfolio using the delta calculated using the pricing information.

18. The system of claim 17, wherein the non-transitory memory stores further instructions that, when executed, cause the one or more processors to:
obtain the pricing information corresponding to the underlying financial product at an end of a trading day.

19. The system of claim 17, wherein the number of call options equals the number of put options, wherein the number is chosen to allow a determined position in the underlying financial product to include a whole number of shares in the underlying financial product.

20. The system of claim 17, wherein the non-transitory memory stores further instructions that, when executed, cause the one or more processors to:
obtain the pricing information corresponding to the underlying financial product at regular intervals during a trading day over a lifetime of the financial product.

21. The system of claim 20, wherein the number of call options equals the number of put options, and wherein the number is chosen to allow a determined position in the underlying financial product to include a fractional number of shares in the underlying financial product.
